(19) United States
(12) Patent Application Publication
(10) Pub. No.: US 2011/0216338 A1
(43) Pub. Date: Sep. 8, 2011

(54) ALIGNMENT MECHANISM FOR SHEET FINISHING APPARATUS, IMAGE FORMING APPARATUS, AND ALIGNMENT METHOD FOR THE SHEET FINISHING APPARATUS

(75) Inventors: Shogo OZAWA, Shizuoka (JP); Kikuo MIZUTANI, Shizuoka (JP)

(73) Assignees: Kabushiki Kaisha Toshiba, Tokyo (JP); Toshiba Tec Kabushiki Kaisha, Tokyo (JP)

(21) Appl. No.: 13/029,686

(22) Filed: Feb. 17, 2011

Related U.S. Application Data
(60) Provisional application No. 61/311,260, filed on Mar. 5, 2010.
(60) Provisional application No. 61/311,262, filed on Mar. 5, 2010.

(51) Int. Cl. G06F 15/00

(52) U.S. Cl. 358/1.13

(57) ABSTRACT

According to one embodiment, a sheet finishing apparatus includes a supporting unit, a positioning unit, a socket mechanism, and a moving unit. The supporting unit supports a sheet fed from an image forming unit. The positioning unit has a contact surface which a side end of the sheet placed on the supporting unit is come into contact with. The socket mechanism projects from the contact surface of the positioning unit and is located above the supporting unit. The moving unit comes into contact with the upper surface of the sheet placed on the supporting unit and moves the sheet in the direction of the contact surface of the positioning unit.

### CROSS-REFERENCE TO RELATED APPLICATION

This application is based upon and claims the benefit of priority from Provisional U.S. Applications 61/311262 filed on Mar. 5, 2010 and 61/311260 filed on Mar. 5, 2010, the entire contents of which are incorporated herein by reference.

### FIELD

Embodiments described herein relate generally to an alignment mechanism for a sheet finishing apparatus which applies a sheet having an image formed thereon, an image forming apparatus, and an alignment method for the sheet finishing apparatus.

### BACKGROUND

There is a sheet finishing apparatus that performs finishing such as stapling or sorting to sheets having an image formed thereon by an image forming apparatus. As the sheet finishing apparatus, there is a device that aligns a sheet using conveying rollers for conveying the sheet in a paper discharge direction.

The device that aligns the sheet moves an offset roller, which comes into contact with the sheet on a processing tray, in a direction crossing a conveying direction of the sheet to thereby come the sheet into contact with a lateral positioning wall and align the sheet.

However, in such a device, when the sheet is bumped against the lateral positioning wall, the sheet may bends and rebounds off the lateral positioning wall. Therefore, it is likely that alignment of the sheet is disordered.

Therefore, there is a demand for development of an alignment mechanism for a sheet finishing apparatus that improves sheet alignment accuracy.

### BRIEF DESCRIPTION OF THE DRAWINGS

FIG. 1 is a schematic view of a MFP according to a first embodiment;

FIG. 2 is a schematic view of a finisher according to the first embodiment;

FIG. 3 is a schematic explanatory view of a sliding mechanism of an alignment unit according to the first embodiment;

FIG. 4 is an enlarged schematic view of a socket mechanism of the alignment unit according to the first embodiment;

FIG. 5A is a schematic explanatory view for explaining a lateral alignment operation for a sheet by the alignment unit according to the first embodiment and a view for explaining a state in which the alignment unit slides;

FIG. 5B is a schematic explanatory view for explaining a lateral alignment operation for a sheet by the alignment unit according to the first embodiment and a view for explaining a state in which the sheet bumps against a lateral alignment plate;

FIG. 6 is an enlarged schematic view of a socket mechanism of an alignment unit according to a second embodiment;

FIG. 7A is a schematic explanatory view for explaining a lateral alignment operation for a sheet by the alignment unit according to the second embodiment and a view for explaining a state in which the alignment unit slides; and

FIG. 7B is a schematic explanatory view for explaining a lateral alignment operation for a sheet by the alignment unit according to the second embodiment and a view for explaining a state in which the sheet bumps against a lateral alignment plate.

### DETAILED DESCRIPTION

According to an embodiment, a sheet finishing apparatus includes: a supporting unit, a positioning unit, a socket mechanism, and a moving unit. The supporting unit supports a sheet fed from an image forming unit. The positioning unit has a contact surface with which a side end of the sheet placed on the supporting unit comes into contact. The socket mechanism projects from the contact surface of the positioning unit, and is located above the supporting unit. The moving unit comes into contact with the upper surface of the sheet placed on the supporting unit and moves the sheet in the direction of the contact surface of the positioning unit.

According to another embodiment, an image forming apparatus includes: an image forming unit, a supporting unit, a positioning unit, a socket mechanism, and a moving unit. The image forming unit forms an image on a sheet. The supporting unit supports the sheet having the image formed thereon by the image forming unit. The positioning unit has a contact surface with which a side end of the sheet placed on the supporting unit comes into contact. The socket mechanism projects from the contact surface of the positioning unit and is located above the supporting unit. The moving unit comes into contact with the upper surface of the sheet placed on the supporting unit and moves the sheet in the direction of the contact surface of the positioning unit.

According to another embodiment, an alignment method for a sheet finishing apparatus includes: placing, on a supporting unit, a sheet discharged from an image forming unit; coming a side end of the sheet into contact with a positioning unit; and coming the upper surface of the sheet and the lower surface of a socket mechanism into contact with each other. Coming a side end of the sheet into contact with a positioning unit is coming a moving unit into contact with a surface of the sheet placed on the supporting unit, moving the sheet in a direction of a contact surface of a positioning unit, and coming a side end of the sheet into contact with the positioning unit. Coming the upper surface of the sheet and the lower surface of a socket mechanism into contact with each other is coming, when the sheet is come into contact with the positioning unit, a lower surface of a socket mechanism projecting from the contact surface of the positioning unit, and located above the supporting unit into contact with an upper surface of the sheet.

The Embodiments of the present invention will be described below with reference to the drawing.

### First Embodiment

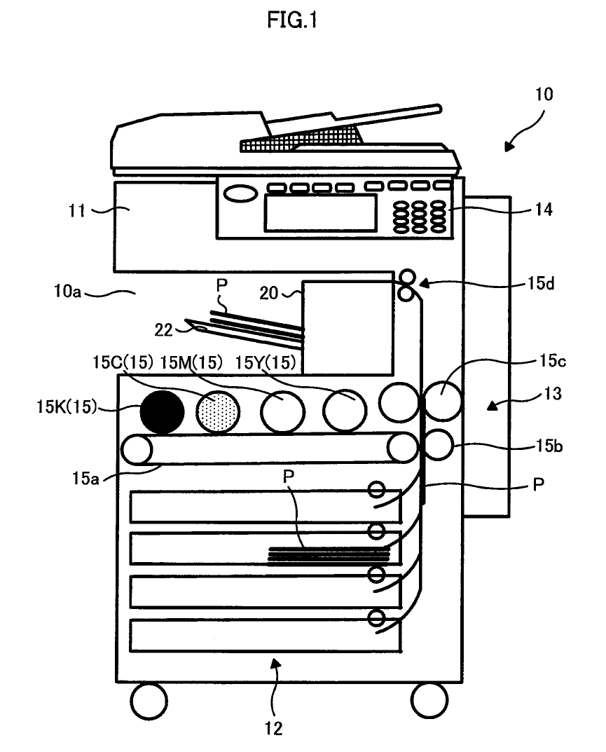

FIG. 1 is a schematic explanatory view of a sheet finishing apparatus (hereinafter referred to as finisher 20) connected to a MFP (Multi Function Peripheral) 10 which is an image forming apparatus according to the first embodiment. The finisher 20 is located in a hollow body 10a formed in the MFP 10 and is connected to a side surface of the MFP 10.

The MFP 10 includes, for example, a scanner 11, a paper feeding unit 12, a printer unit 13, and a control panel 14. The MFP 10 reads, with the scanner 11, a print, a photograph, or the like as image data according to operation of the control panel 14 by a user. The MFP 10 forms, with the printer unit 13, an image corresponding to the read image data on a sheet P, which is fed from the paper feeding unit 12.

The printer unit 13 includes stations 15 for plural colors, a transfer belt 15a, a transfer unit 15b, a fixing unit 15c, and a paper discharge roller pair 15d. After forming toner images corresponding to the image data with, for example, stations 15Y, 15M, 15C, and 15K for yellow (Y), magenta (M), cyan (C), and black (K), the printer unit 13 forms a color toner image on the transfer belt 15a. The printer unit 13 transfers, with the transfer unit 15b, the color toner image on the transfer belt 15a onto the sheet P fed from the paper feeding unit 12. The printer unit 13 fixes, with the fixing unit 15c, the color toner image on the sheet P. In this way, the printer unit 13 forms the image on the sheet P. After forming the image on the sheet P, the printer unit 13 discharges the sheet P from the paper discharge roller pair 15d and feeds the sheet P to the finisher 20.

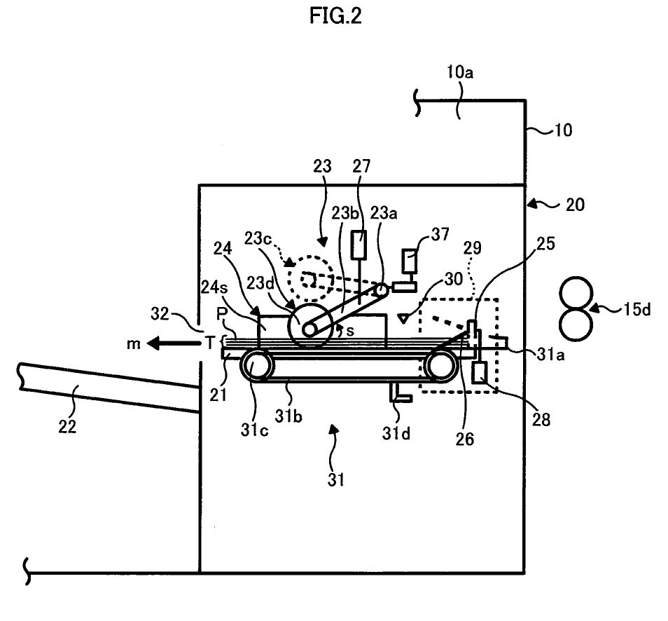

FIG. 2 is a schematic view of the finisher 20 according to the first embodiment. As shown in FIG. 2, the finisher 20 includes a processing tray 21 and a paper discharge tray 22. The processing tray 21 is a supporting unit on which the sheet P supplied from the paper discharge roller pair 12 is placed for finishing. The paper discharge tray 22 is a supporting unit in which the sheet P conveyed from the processing tray 21 is stored.

The finisher 20 includes an alignment unit23, a lateral alignment plate 24, and a longitudinal alignment plate 25. The alignment unit23 serves as a moving unit. The lateral alignment plate 24 and the longitudinal alignment plate 25 serve as a positioning unit. The finisher 20 includes a chuck 26 which suppresses the sheet P from shifting on the processing tray 21.

The alignment unit 23 includes an alignment roller 23c at the distal end of an arm 23b rotating about a shaft 23a serving as a fulcrum. The arm 23b rotates according to ON and OFF operations of an arm solenoid 27. When the arm solenoid 27 is ON, the arm 23b rotates as indicated by a dotted line in FIG. 2 and the alignment roller 23c moves away from the sheet P on the processing tray 21. When the arm solenoid 27 is OFF, the arm 23b rotates by its own weight as indicated by a solid line in FIG. 2 and the alignment roller 23c comes into contact with the upper surface of the sheet P on the processing tray 21. A section of the alignment roller 23c coming into contact with the sheet P is formed of a tube 23d having elasticity.

The longitudinal alignment plate 25 is located at the rear end of the processing tray 21 and perpendicular to a conveying direction m of the sheet P. At the time of alignment, the trailing end of the sheet P, which is a side end of the sheet P, comes into contact with the longitudinal alignment plate 25, and the longitudinal alignment plate 25 thus longitudinally aligns the sheet P. The longitudinal alignment plate 25 has openings through which ejectors 31a explained later pass.

The lateral alignment plate 24 is located at a lateral end of the processing tray 21 and parallel to the conveying direction m of the sheet P. The lateral alignment plate 24 has a contact surface 24s which the sheet P comes into contact with. At the time of alignment, the lateral end of the sheet P, which is a side end of the sheet P, comes into contact with the lateral alignment plate 24 to laterally align the sheet P.

The chuck 26 opens and closes according to ON and OFF operations of a chuck solenoid 28. When the chuck solenoid 28 is ON, the chuck 26 opens as indicated by a dotted line in FIG. 2. When the chuck solenoid 28 is OFF, the chuck 26 closes as indicated by a solid line in FIG. 2. The chuck 26 opens while the sheet P is aligned on the processing tray 21. When alignment operation for the sheet P is finished, the chuck 26 closes.

The finisher 20 includes, for example, a stapler 29 for performing binding of sheets P as finishing and a sensor 30 which detects a paper jam of the sheet P. The finisher 20 includes the conveying mechanism 31 which conveys the sheet P on the processing tray 21 to the paper discharge tray 22.

The conveying mechanism 31 includes a pair of ejectors 31a projecting from the rear end surface of the processing tray 21, a conveyor belt 31b located between the pair of ejectors 31a, and an outlet roller 31c. The ejectors 31a push out the sheet P or a sheet bundle T which locates on the processing tray 21.

The conveyor belt 31b includes a pawl section 31d. When the sheet P is guided onto the processing tray 21 or when the sheet P is guided onto the processing tray 21 and sorting or stapling of a plurality of the sheets P is ended, the ejectors 31a pass through the openings of the longitudinal alignment plate 25 and move onto the processing tray 21 and the outlet roller 31c rotates. The ejectors 31a and the outlet roller 31c move the sheet P or the sheet bundle T including the plural sheets P in the direction of the paper discharge tray 22 and start discharge of the sheet P or the sheet bundle T. Thereafter, when the conveyor belt 31b rotates and the pawl section 31d overtakes the ejectors 31a, the pawl section 31d and the outlet roller 31c discharge the sheet P or the sheet bundle T from a paper discharge port 32 to the paper discharge tray 22. When the pawl section 31d discharges the sheet P or the sheet bundle T, the ejectors 31a return to the rear end direction of the processing tray 21 with the force of a spring.

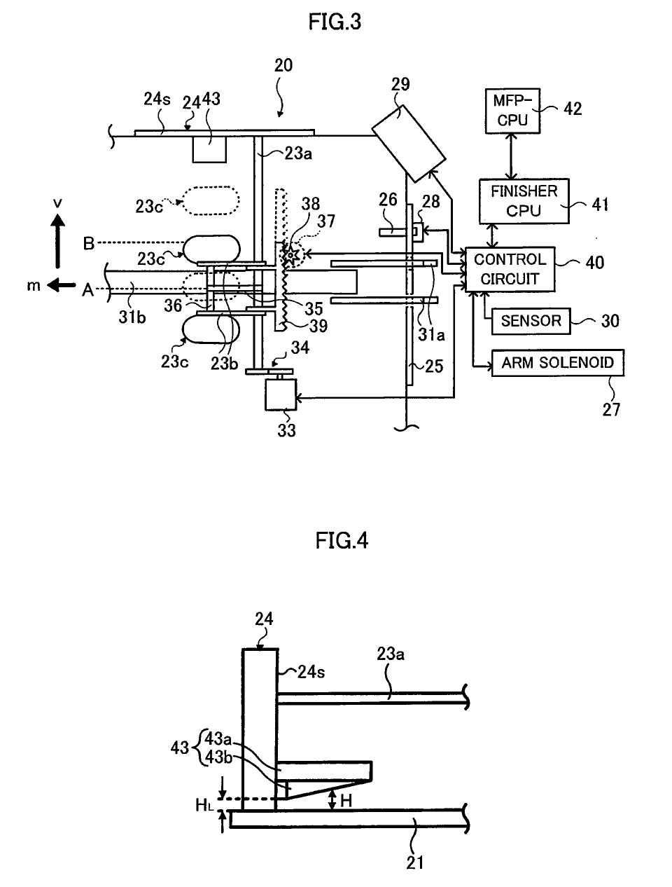

FIG. 3 is a schematic explanatory view of a sliding mechanism of the alignment unit 23 according to the first embodiment. As shown in FIG. 3, a roller motor 33 rotates the alignment roller 23c via a link gear 34, the shaft 23a, a timing belt 35, and a roller shaft 36. When the sheet P is longitudinally aligned, the alignment roller 23c rotates in an arrow s direction. When the sheet P is laterally aligned, the rotation of the alignment roller 23c stops.

The alignment unit 23 slides in a direction crossing an arrow m direction, which is the conveying direction of the sheet P. As a rack 39 is slid by a pinion gear 38 driven by a gear motor 37, the arm 23b of the alignment unit 23 slides along the shaft 23a.

A control circuit 40 is controlled by a finisher CPU 41 which controls the finisher 20. The control circuit 40 and the finisher CPU 41 are adjusting units. The finisher CPU 41 is connected to a MFP-CPU 42 which controls the MFP 10. The control circuit 40 controls the stapler 29, the arm solenoid 27, the gear motor 37, the chuck solenoid 28, the roller motor 33, the ejectors 31a, the conveyor belt 31b, and the outlet roller 31c. A detection result of the sensor 30 is input to the control circuit 40.

The lateral alignment plate 24 includes a socket mechanism 43 which suppresses the sheet P from bending and rebounding off the lateral alignment plate 24 when the sheet P is laterally aligned.

FIG. 4 is an enlarged schematic view of the socket mechanism 43 according to the first embodiment. As shown in FIG. 4, the socket mechanism 43 includes a projecting section 43a located above the processing tray 21 and an elastic member 43b come in contact with the lower surface of the projecting section 43a. The projecting section 43a is fixed on the contact surface 24s of the lateral alignment plate 24 and is projecting from the contact surface 24s of the lateral alignment plate 24. The elastic member 43b is, for example, rubber or gel.

The shape of the elastic member 43b shown in FIG. 4 is desirably a triangle. Specifically, the elastic member 43b is desirably formed such that height H of the socket mechanism 43 decreases toward an arrow v direction, which is a moving direction of the alignment unit 23. In other words, the elastic member 43b is desirably formed such that height H of the socket mechanism 43 decreases toward the lateral alignment plate 24. Height H of the socket mechanism 43 refers to height from the upper surface of the processing tray 21 to the lower surface of the elastic member 43b.

When print is started, after forming the image on the sheet P, the MFP 10 discharges the sheet P to the finisher 20 side. The finisher 20 receives the sheet P fed from the MFP 10. While the sheet P is received, the alignment roller 23c of the finisher 20 stays away from the processing tray 21.

(1) Case where finishing of the sheet P is not performed

As the sensor 30 detects that the guiding of the sheet P onto the processing tray 21 is finished, the control circuit 40 drives the conveying mechanism 31 including the ejectors 31a, the conveyor belt 31b, and the outlet roller 31c. The conveying mechanism 31 discharges the sheet P on the processing tray 21 to the paper discharge tray 22.

(2) Case where, for example, the sheets P are discharged as a bundle, as finishing of the sheets P

As the sensor 30 detects that the guiding of a first sheet P onto the processing tray 21 is finished, the control circuit 40 turns on the chuck solenoid 28 to open the chuck 26 and turns off the arm solenoid 27 to come the alignment roller 23c into contact with the first sheet P. The control circuit 40 rotates the roller motor 33 by a predetermined amount and rotates the alignment roller 23c in the arrow s direction shown in FIG. 2. The alignment roller 23c conveys the sheet P in a direction opposite to the arrow m direction and comes the trailing end of the sheet P into contact with the longitudinal alignment plate 25 to longitudinally align the sheet P.

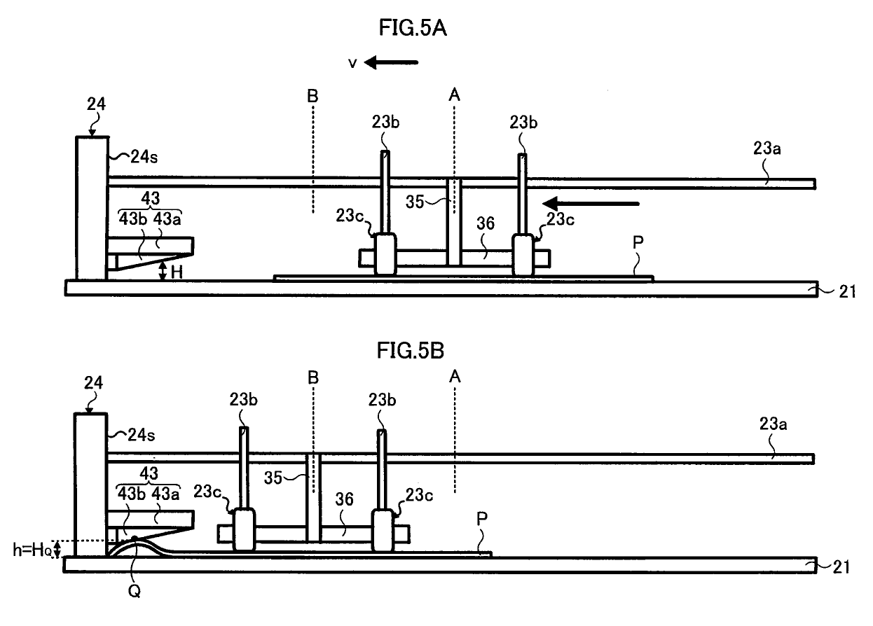

FIG. 5A is a schematic explanatory view for explaining a lateral alignment operation for the sheet by the alignment unit according to the first embodiment and a view for explaining a state in which the alignment unit slides. FIG. 5B is a schematic explanatory view for explaining the lateral alignment operation for the sheet by the alignment unit according to the first embodiment and a view for explaining a state in which the sheet bumps against the lateral alignment plate.

The control circuit 40 rotates the gear motor 37 to slide the alignment unit 23 in the arrow v direction (FIG. 5A). When the alignment unit 23 slides, the alignment roller 23c moves the sheet P in the arrow v direction with frictional force. When the control circuit 40 slides the alignment unit 23 in the arrow v direction from an A position to a B position (both the A position and the B position refer to the position in the center of the roller shaft 36), the lateral end of the sheet P comes into contact with the contact surface 24s of the lateral alignment plate 24 and the sheet P is laterally aligned (FIG. 5B).

As shown in FIG. 5B, when the sheet P bumps against the lateral alignment plate 24 and curves, a part of the upper surface of the sheet P comes into contact with a contact point Q on the lower surface of the socket mechanism 43 (the contact point Q refers to a point where a part of the upper surface of the sheet P and the socket mechanism 43 come into contact with each other) . When the sheet P comes into contact with the contact point Q, the sheet P curves with a curve amount h (the curve amount h refers to height from the upper surface of the processing tray 21 to the contact point Q). However, the curve amount h of the sheet P does not increases to be larger than height H_{Q} of the socket mechanism 43 at the contact point Q. In this way, the socket mechanism 43 can suppress an increase of the curve amount h of the sheet P. Therefore, the socket mechanism 43 can suppress the sheet P from rebounding off the lateral alignment plate 24 to improve alignment accuracy.

The curve amount h of the sheet P is smaller as the height H of the socket mechanism 43 is smaller. Therefore, it is more desirable that the height H of the socket mechanism 43 is smaller.

When the lateral alignment of the first sheet P is finished, the control circuit 40 turns on the arm solenoid 27 and rotates the gear motor 37. The alignment roller 23c moves away from the sheet P. The alignment unit 23 slides in a direction opposite to the arrow v direction and returns from the B position to the A position.

The control circuit 40 aligns a predetermined number of second and subsequent sheets P on the processing tray 21 in the same manner as the alignment of the first sheet P. The second and subsequent sheets P also come into contact with the longitudinal alignment plate 25 to be longitudinally aligned and come into contact with the contact surface 24s of the lateral alignment plate 24 to be laterally aligned. Even when the lateral ends of the second and subsequent sheets P bump against the contact surface 24s of the lateral alignment plate 24 and the sheets P curve, the sheets P come into contact with the lower surface of the socket mechanism 43. Therefore, the socket mechanism 43 can suppresses an increase of the curve amount h of the sheets P, respectively.

As explained above, it is more desirable that the height H of the socket mechanism 43 is smaller. However, if the height H of the socket mechanism 43 is too small, the lateral ends of the second and subsequent sheets P do not reach the lateral alignment plate 24 and bump against the lower surface or a side surface of the socket mechanism 43 when lateral alignment is performed. As a result, since the sheets P curve and rebound off the socket mechanism 43, the sheets P are not aligned. Therefore, minimum height H_{L} shown in FIG. 4 needs to be higher than thickness of a maximum number of the sheets P aligned on the processing tray 21. It is desirable that the socket mechanism 43 is located above the processing tray 21 such that, the minimum height H_{L} is as small as possible within a range in which the height H_{L} is larger than the thickness of the maximum number of the sheets P aligned on the processing tray 21.

When the alignment of the sheet P included in the predetermined number of sheets P (the sheet bundle T) is finished, the control circuit 40 turns off the chuck solenoid 28 to close the chuck 26 and suppresses the sheets P included in the sheet bundle T from shifting. The control circuit 40 operates the conveying mechanism 31. The conveying mechanism 31 discharges the sheet bundle T on the processing tray 21 to the paper discharge tray 22.

When stapling of the sheets P is performed as finishing, after the predetermined number of sheets P (the sheet bundle T) aligned on the processing tray 21 are stapled by the stapler 29, the conveying mechanism 31 discharges the stapled sheet bundle T to the paper discharge tray 22.

In the finisher 20 according to the first embodiment, the socket mechanism 43 is fixed on the contact surface 24s of the lateral alignment plate 24. Therefore, when the lateral end of the sheet P bumps against the contact surface 24s of the lateral alignment plate 24 and the sheet P curves, the curve mount h of the sheet P is suppressed to the height H of the socket mechanism 43. Therefore, it is possible to suppress the sheet P from rebounding off the lateral alignment plate 24 to improve alignment accuracy.

The elastic member 43b is formed on the lower surface of the projecting section 43a of the socket mechanism 43. Therefore, when the sheet P comes into contact with the socket mechanism 43, the elastic member 43b can suppress the sheet P from being scratched.

The elastic member 43b is formed such that the height H of the socket mechanism 43 decreases toward the lateral alignment plate 24, whereby it can be easy to insert the sheet P between the processing tray 21 and the socket mechanism 43. Therefore, the height H of the socket mechanism 43 can beset as small as possible within a range in which the height H is larger than the thickness of the maximum number of sheets P aligned on the processing tray 21. Therefore, it is possible to suppress the sheet P from bumping against the side surface of the socket mechanism 43 and rebounding and, at the same time, further reduce the curve amount h of the sheet P. Therefore, it is possible to further improve the alignment accuracy of the sheet P.

### Second Embodiment

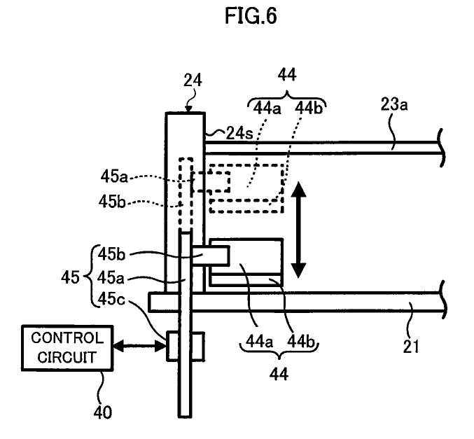

FIG. 6 is an enlarged schematic view of a socket mechanism according to a second embodiment. As shown in FIG. 6, the lateral alignment plate 24 includes a socket mechanism 44. The socket mechanism 44 is supported by a driving unit 45. The driving unit 45 can move the socket mechanism 44 to the vertical direction. The socket mechanism 44 includes a projecting section 44a and an elastic member 44b come in contact with the lower surface of the projecting section 44a. The projecting section 44a is located above the processing tray 21. The projecting section 44a is supported in a position slightly away from the contact surface 24s of the lateral alignment plate 24 by the driving unit 45 and is projecting from the contact surface 24s of the lateral alignment plate 24. A sectional shape of the elastic member 44b shown in FIG. 6 is a rectangle. Specifically, the elastic member 44b is formed such that the lower surface of the elastic member 44b and the upper surface of the processing tray 21 are parallel. However, as shown in FIG. 4, the elastic member 44b may be triangular.

The driving unit 45 supports the socket mechanism 44 in a position slightly away from the contact surface 24s of the lateral alignment plate 24 and moves the socket mechanism 44 to the vertical direction. The driving unit 45 includes a supporting member 45a, a supporting arm 45b, and a solenoid for socket mechanism 45c. The supporting member 45a is, for example, a supporting bar formed in a bar shape and is located on the inside of the lateral alignment plate 24. The supporting arm 45b projects in an outside direction from the inside of the lateral alignment plate 24. One end of the supporting arm 45b is connected to the supporting member 45a and the other end of the supporting arm 45b is connected to the projecting section 44a. The solenoid for socket mechanism 45c is connected to the control circuit 40. The solenoid for socket mechanism 45c moves the supporting member 45a to the vertical direction on the basis of ON and OFF signals sent from the control circuit 40. When the solenoid for socket mechanism 45c is ON, the supporting member 45a ascends as indicated by a dotted line in FIG. 6. When the solenoid is OFF, the supporting member 45a descends by its own weight as indicated by a solid line in FIG. 6. The socket mechanism 44 stays in a lifted state while the sheet P is aligned on the processing tray 21 and descends when alignment operation for the sheet P finishes.

In the finisher 20 including the socket mechanism 44 according to the second embodiment, the operation of the finisher 20 in not performing finishing of the sheet P is the same as that in the first embodiment. For example, when the finisher 20 performs discharge of a bundle of the sheets P as finishing of the sheets P, the finisher 20 operates as explained below.

As the sensor 30 detects that the guiding of a first sheet P onto the processing tray 21 is finished, the control circuit 40 turns on the chuck solenoid 28 to open the chuck 26, turns off the arm solenoid 27 to bring the alignment roller 23c into contact with the first sheet P, and turns on the solenoid for socket mechanism 45c to lift the socket mechanism 44.

The control circuit 40 rotates the roller motor 33 by a predetermined amount and comes the trailing end of the sheet P into contact with the longitudinal alignment plate 25 to longitudinally align the sheet P.

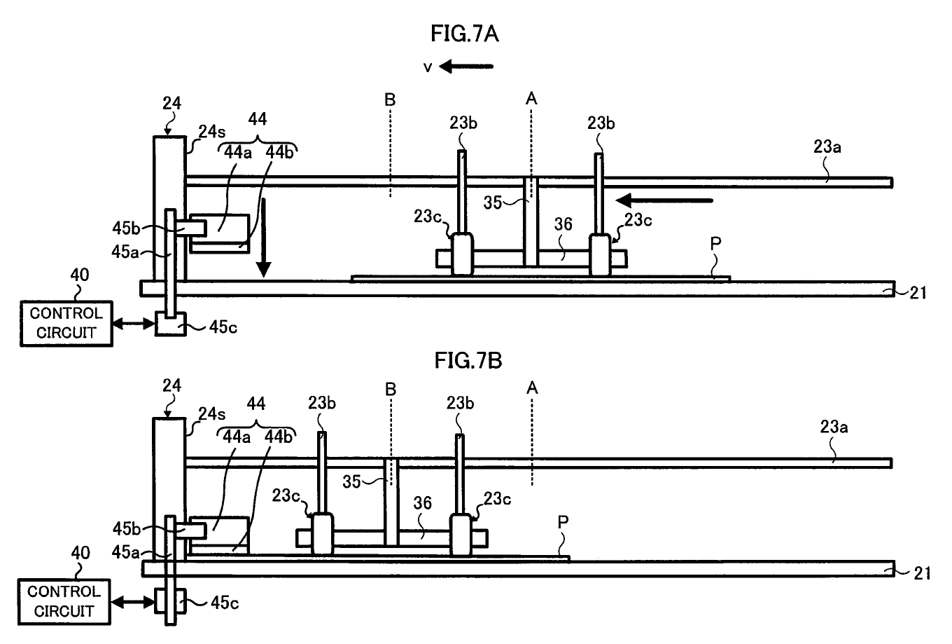

FIG. 7A is a schematic explanatory view for explaining a lateral alignment operation for the sheet by the alignment unit according to the second embodiment and a view for explaining a state in which the alignment unit slides. FIG. 7B is a schematic explanatory view for explaining a lateral alignment operation for the sheet by the alignment unit according to the second embodiment and a view for explaining a state in which the sheet bumps against the lateral alignment plate.

The control circuit 40 rotates the gear motor 37 and slides the alignment unit 23 in the arrow v direction (FIG. 7A). When the alignment unit 23 is slid in the arrow v direction from an A position to a B position, the lateral end of the sheet P comes into contact with the contact surface 24s of the lateral alignment plate 24. When the control circuit 40 moves the alignment unit 23 by a predetermined amount, the control circuit 40 turns off the solenoid for socket mechanism 45c. When the solenoid for socket mechanism 45c is turned off, the socket mechanism 44 descends until the lower surface of the socket mechanism 44 comes into contact with the sheet P (FIG. 7B).

As shown in FIG. 7B, simultaneously with the lateral end of the sheet P bumping against the contact surface 24s of the lateral alignment plate 24, the socket mechanism 44 descends until coming into contact with the sheet P. Therefore, even if the sheet P bumps against the contact surface 24s of the lateral alignment plate 24, the sheet P hardly curves. In this way, the socket mechanism 44 can suppress an increase of the curve amount h of the sheet P. Therefore, the socket mechanism 44 can further suppress the sheet P from rebounding off the lateral alignment plate 24, and further improve the alignment accuracy.

When the lateral alignment of the first sheet P is finished, the control circuit 40 turns on the arm solenoid 27 to rotate the gear motor 37. The alignment roller 23c moves away from the sheet P. The alignment unit 23 slides in a direction opposite to the arrow v direction and returns from the B position to the A position. At the same time, the control circuit 40 turns on the solenoid for socket mechanism 45c to lift the socket mechanism 44.

The control circuit 40 aligns a predetermined number of second and subsequent sheets P on the processing tray 21 in the same manner as the alignment of the first sheet P. The second and subsequent sheets P also come into contact with the lateral alignment plate 24 to be laterally aligned. Simultaneously with the lateral ends of the second and subsequent sheets P bumping against the contact surface 24s of the lateral alignment plate 24, the socket mechanism 44 descends until coming into contact with the sheets P and suppresses the sheets P from curving, respectively.

When the alignment of the predetermined number of sheets P is finished, the control circuit 40 turns on the solenoid for socket mechanism 45c to lift the socket mechanism 44. At the same time, the control circuit 40 turns off the chuck solenoid 28 to close the chuck 26 and prevents the sheets P of the sheet bundle T including the predetermined number of sheets P from shifting. The control circuit 40 drives the conveying mechanism 31. The conveying mechanism 31 discharges the sheet bundle T on the processing tray 21 to the paper discharge tray 22.

When stapling of the sheets P is performed as finishing, after the predetermined number of sheets P aligned on the processing tray 21 are stapled by the stapler 29, the conveying mechanism 31 discharges the stapled sheet bundle T to the paper discharge tray 22.

According to the second embodiment, simultaneously with the sheet P coming into contact with the contact surface 24s of the lateral alignment plate 24, the socket mechanism 44 descends until coming into contact with the sheet P. Therefore, if the sheet P bumps against the contact surface 24s of the lateral alignment plate 24, an increase of a curve amount of the sheet P is substantially completely suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the finishing operation performed by the sheet finishing apparatus is not limited to the stapling operation. The finishing operation can be punching operation, folding operation, and the like.

The shapes of the moving unit and the like, the driving mechanism, and the like are not limited. The alignment roller may be formed of a material having elasticity such as foamed urethane.

What is claimed is:

1. A sheet finishing apparatus comprising:
a supporting unit which supports a sheet fed from an image forming unit;
a positioning unit having a contact surface with which a side end of the sheet placed on the supporting unit comes into contact;
a socket mechanism which is projecting from the contact surface of the positioning unit, and is located above the supporting unit; and
a moving unit which comes into contact with an upper surface of the sheet placed on the supporting unit and moves the sheet in a direction of the contact surface of the positioning unit.

2. The sheet finishing apparatus according to claim 1, wherein the socket mechanism includes a projecting section located above the supporting unit, projecting from the surface of the positioning unit, and fixed to the contact surface of the positioning unit.

3. The sheet finishing apparatus according to claim 2, wherein the socket mechanism includes an elastic member come in contact with a lower surface of the projecting section.

4. The sheet finishing apparatus according to claim 3, wherein the elastic member is formed such that a distance between a lower surface of the elastic member and an upper surface of the supporting unit decreases in a moving direction of the moving unit.

5. The sheet finishing apparatus according to claim 1, further having a driving unit which moves the socket mechanism, wherein
the driving unit controls, simultaneously with the sheet coming into contact with the contact surface of the positioning unit, the socket mechanism such that a lower surface of the socket mechanism comes into contact with the sheet.

6. The sheet finishing apparatus according to claim 5, wherein the socket mechanism includes a projecting section located above the supporting unit, projecting from the surface of the positioning unit, and away from the contact surface of the positioning unit.

7. The sheet finishing apparatus according to claim 6, wherein the socket mechanism includes an elastic member come in contact with a lower surface of the projecting section.

8. The sheet finishing apparatus according to claim 7, wherein the elastic member is formed such that a distance between a lower surface of the elastic member and an upper surface of the supporting unit decreases in a moving direction of the moving unit.

9. An image forming apparatus comprising:
an image forming unit which forms an image on a sheet;
a supporting unit which supports the sheet having the image formed thereon by the image forming unit;
a positioning unit having a contact surface with which a side end of the sheet placed on the supporting unit comes into contact;
a socket mechanism which is projecting from the contact surface of the positioning unit, and is located above the supporting unit; and
a moving unit which comes into contact with an upper surface of the sheet placed on the supporting unit and moves the sheet in a direction of the contact surface of the positioning unit.

10. The image forming apparatus according to claim 9, wherein the socket mechanism includes a projecting section located above the supporting unit, projecting from the surface of the positioning unit, and fixed to the contact surface of the positioning unit.

11. The image forming apparatus according to claim 10, wherein the socket mechanism includes an elastic member come in contact with a lower surface of the projecting section.

12. The image forming apparatus according to claim 11, wherein the elastic member is formed such that a distance between a lower surface of the elastic member and an upper surface of the supporting unit decreases in a moving direction of the moving unit.

13. The image forming apparatus according to claim 12, further having a driving unit which moves the socket mechanism, wherein
the driving unit controls, simultaneously with the sheet coming into contact with the contact surface of the positioning unit, the socket mechanism such that a lower surface of the socket mechanism comes into contact with the sheet.

14. The image forming apparatus according to claim 13, wherein the socket mechanism includes a projecting section located above the supporting unit, projecting from the surface of the positioning unit, and away from the contact surface of the positioning unit.

15. The image forming apparatus according to claim 14, wherein the socket mechanism includes an elastic member come in contact with a lower surface of the projecting section.

16. The image forming apparatus according to claim 15, wherein the elastic member is formed such that a distance between a lower surface of the elastic member and an upper surface of the supporting unit decreases in a moving direction of the moving unit.

17. An alignment method for a sheet finishing apparatus, comprising:
placing a sheet discharged from an image forming unit on a supporting unit;
coming a moving unit into contact with a surface of the sheet placed on the supporting unit, moving the sheet in a direction of a contact surface of a positioning unit, and coming a side end of the sheet into contact with the positioning unit; and
coming, when the sheet is come into contact with the positioning unit, a lower surface of a socket mechanism projecting from the contact surface of the positioning unit, and located above the supporting unit into contact with an upper surface of the sheet.

18. The alignment method for a sheet finishing apparatus according to claim 17, wherein the sheet is bumped against the contact surface of the positioning unit and the sheet curves, therefore the upper surface of the sheet and the lower surface of the socket mechanism come into contact with each other.

19. The alignment method for a sheet finishing apparatus according to claim 17, wherein the socket mechanism is lowered simultaneously with the sheet being come into contact with the contact surface of the positioning unit, therefore the upper surface of the sheet and the lower surface of the socket mechanism come into contact with each other.

20. The alignment method for a sheet finishing apparatus according to claim 17, wherein the upper surface of the sheet comes into contact with an elastic member of the socket mechanism including a projecting section formed on the contact surface of the positioning unit and the elastic member come in contact with a lower surface of the projecting section.
